(19) United States
(12) Patent Application Publication
(10) Pub. No.: US 2014/0289431 A1
(43) Pub. Date: Sep. 25, 2014

(54) INTERFACE APPARATUS CONNECTED WITH ELECTRONIC DEVICE

(71) Applicant: HON HAI PRECISION INDUSTRY CO., LTD., New Taipei (TW)

(72) Inventors: WEI-CHING CHIEN, New Taipei (TW); MENG-FENG KUO, New Taipei (TW); CHU-LIAO WANG, New Taipei (TW)

(73) Assignee: HON HAI PRECISION INDUSTRY CO., LTD., New Taipei (TW)

(21) Appl. No.: 14/101,404

(22) Filed: Dec. 10, 2013

(30) Foreign Application Priority Data
Mar. 20, 2013 (TW) 102109939

(51) Int. Cl. G06F 13/10

(52) U.S. Cl. CPC G06F 13/10
USPC 710/62

(57) ABSTRACT

An interface apparatus is capable of connecting with a plurality of external devices and an electronic device. The electronic device generates control signals and a selecting signal. The interface apparatus comprises a plurality of interface ports, an interface, a selection unit, and a switch. The interface ports connect with the external devices respectively. The interface controls the switch to establish a connection between the selection unit and the interface in response to the first control signal for transmitting the selecting signal to the selection unit. The selection unit selects the interface port corresponding to the selecting signal to connect with the switch. The interface further transmits information from the external device corresponding to the selected interface port to the electronic device through the switch and the interface in that order in response to the second control signal.

### BACKGROUND

1. Technical Field

The present disclosure relates to an interface apparatus connected with an electronic device, and an electronic device for extending the number of connecting ports by the connected interface apparatus.

2. Description of Related Art

An interface extension apparatus connects with an electronic device for extending the number of connecting ports of the electronic device. The interface extension apparatus includes a power supply, a connecting port, and a plurality of extension interface ports. The power supply powers the extension interface ports and the connecting port. The connecting ports are used for connecting with the electronic device. The extension interface ports respectively connect to a plurality of external devices. However, the power supply of the interface extension apparatus increases the difficulty in circuit design process, and one of the extension interface ports is manually selected for establishing a connection between the corresponding external device and the electronic device.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device connecting with a plurality of external device through an interface apparatus in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

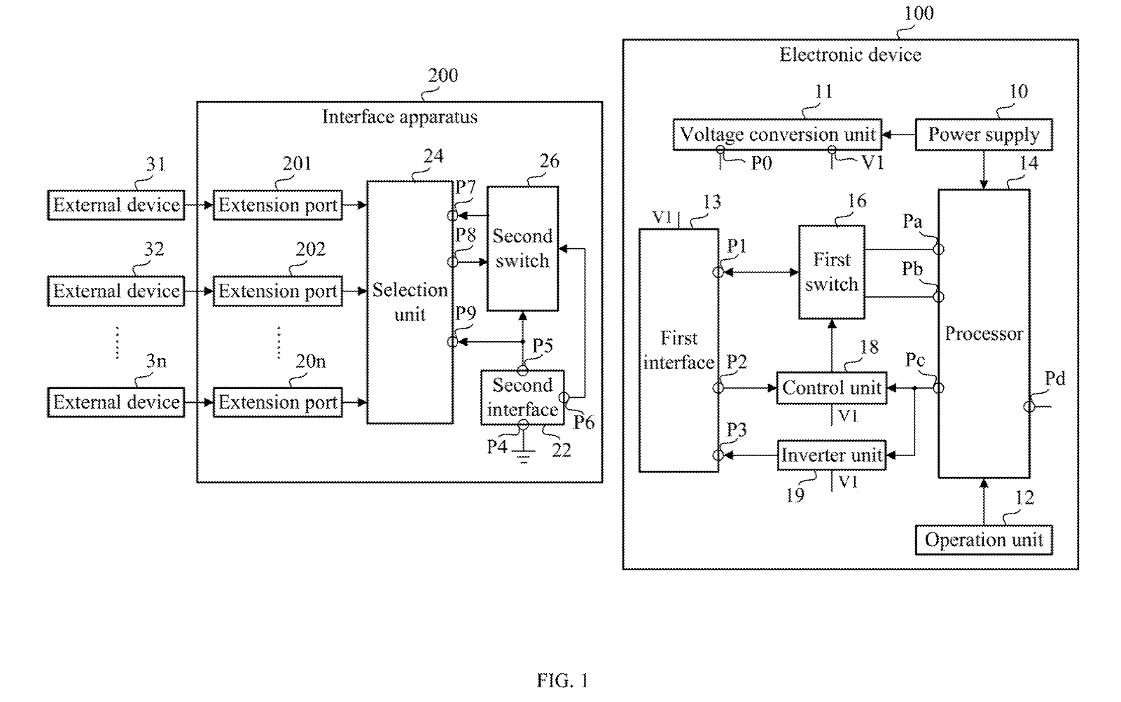

FIG. 1 shows an electronic device 100 of one embodiment of the present disclosure. The electronic device 100 is capable of connecting with different external devices 31-3n through an interface apparatus 200 simultaneously. The electronic device 100 powers the interface apparatus 200 and automatically selects one of the external devices 31-3n for intercommunicating information. In the embodiment, the external devices 31-3n can be PlayStation 3 (PS3), DVD player, or Xbox 360, for example, and the electronic device 100 is hot-plug connected with the interface apparatus 200.

The electronic device 100 includes a power supply 10, a voltage conversion unit 11, an operation unit 12, a first interface 13, a processor 14, a first switch 16, a control unit 18, and an inverter unit 19.

The power supply 10 provides a working voltage to the voltage conversion unit 11 and the processor 14. In the embodiment, the working voltage is 3.3 volt (V).

The voltage conversion unit 11 is connected to the power supply 10, the first interface 13, the first switch 16, and the control unit 18. The voltage conversion unit converts the working voltage into a driving voltage when the first interface 13 connects with the interface apparatus 200. The voltage conversion unit 11 includes a detecting pin PO and a voltage output pin V1. The detecting pin PO is connected to the first interface 13, and is capable of converting the working voltage into a driving voltage when the first interface 13 connects with the interface apparatus 200. The voltage output pin V1 is connected to the first interface 13, the first switch 16, the control unit 18, and the inverter unit 19. The voltage output pin V1 provides the driving voltage to the first interface 13, the first switch 16, the control unit 18, and the inverter unit 19.

The operation unit 12 is connected with the processor 14. The operation unit 12 is used for generating a corresponding selecting signal based on operations of users.

The first interface unit 13 is connected to the voltage conversion unit 11, the first switch 16, the control unit 18, and the inverter unit 19. The first interface unit 13 is capable of powering the interface apparatus 200 when being connected with interface apparatus 200 and intercommunicating signals and information with the interface apparatus 200. The first interface unit 13 includes a first pin P1, a second pin P2, and a third pin P3. The first pin P1 is connected to the first switch 16. The second pin P2 is connected to the detecting pin P0, the control unit 18, and the interface apparatus 200. The third pin P3 is connected to the inverter unit 19. In the embodiment, the first interface unit 13 is a high definition multimedia interface (HDMI).

The processor 14 includes a first output pin Pa, a first input pin Pb, a first control pin Pc, and a first enable pin Pd. The first output pin Pa and the first input pin Pb are connected to the first switch 14. The first output pin Pa is capable of transmitting the corresponding selecting signal generated by the operation unit 12, or a default selecting signal which corresponds to one of the external devices 31-3n when there is no corresponding selecting signal generated by the operation unit 12. The first input pin Pb is capable of receiving information from the interface apparatus 200. The first control pin Pc is connected to the control unit 18 and the inverter unit 19. The first control pin Pc generates a first control signal in a predetermined time period from a time point when the first interface unit 13 connects with the interface apparatus 200. The first control pin Pc further generates a second control signal after the predetermined time period. The first enable pin Pd is connected to the second pin P2 for detecting whether the first interface 13 connects with the interface apparatus 200. In the embodiment, the first control signal is a logic-high signal, and the second control signal is a logic-low signal.

The first switch 16 is connected to the first interface 13, the output pin Pa, and the input pin Pb. The first switch 16 is capable of establishing a connection between the first pin P1 and the first output pin Pa or establishing a connection between the first pin P1 and the first input pin Pb.

The control unit 18 is connected to the first interface 10 and the processor 14. The control unit 18 controls the first switch 16 to establish the connection between the first pin P1 and the first output pin Pa for transmitting the corresponding selecting signal or the default selecting signal to the interface apparatus 200 in response to the first control signal. The control unit 18 further controls the first switch 16 to establish the connection between the first interface 13 and the first input pin Pb in response to the second control signal for receiving information from the interface apparatus 200.

The inverter unit 19 is connected to the first interface 13 and the processor 14. The inverter unit 19 inverts the first control signal to the second control signal in the predetermined time period for transmission to the interface apparatus 200, and further inverts the second control signal to the first control signal after the predetermined time period for transmission to the interface apparatus 200.

The interface apparatus 200 includes a plurality of interface ports 201-20n, a second interface 22, a selection unit 24, and a second switch 26. The interface ports 201-20n corresponds to the external devices 31-3n in a one-to-one relationship. In the embodiment, the interface ports 201-20n are HDMI type ports, and the second interface 22 is HDMI interface; the interface 201 corresponds to the default selecting signal.

The second interface 22 is connected to the selection unit 24 and the second switch 26. The second interface 22 is capable of connecting with the first interface 13. The second interface 22 includes a trigger pin P4, a transmitted pin P5, and a second control pin P6. The trigger pin P4 is capable of transmitting a connecting signal to the second pin P2 when being connected with the second pin P2 of the first interface 13. The transmitted pin P5 is connected to the selection unit 24 and the second switch 26. The transmitted pin P5 is capable of transmitting the driving voltage to the selection unit 24 and the second switch 26 and receiving control signals from the inverter unit 19. The second control pin P6 is connected to the second switch 26. The second control pin P6 transmits control signals from the inverter unit 19 to the second switch 26. In the embodiment, the connecting signal is a logic-low signal.

The selection unit 24 is connected to the second interface 22 and the plurality of interface ports 201-20n. The selection unit 24 includes a second input pin P7, a second output pin P8, and a second enable pin P9. The second input pin P7 and the second output pin P8 are connected to the second switch 26. The second input pin P7 is capable of receiving the corresponding selecting signal or the default selecting signal transmitted by the second interface 22. The second output pin P8 is capable of connecting with one of the interface ports 201-20n corresponding to the received selecting signal for transmitting information from one of the interface ports 201-20n. The second enable pin P9 is connected with the second interface 22, and receives driving voltage from the voltage conversion unit 11.

The second switch 26 is connected to the second interface 22 and the selection unit 24. The second switch 26 establishes a connection between the second interface 22 and the second input pin P7 in response to the second control signal inverted by the inverter unit 19. The second switch 26 further establishes a connection between the second interface 22 and the second output pin P8 in response to the first control signal inverted by the inverter unit 19.

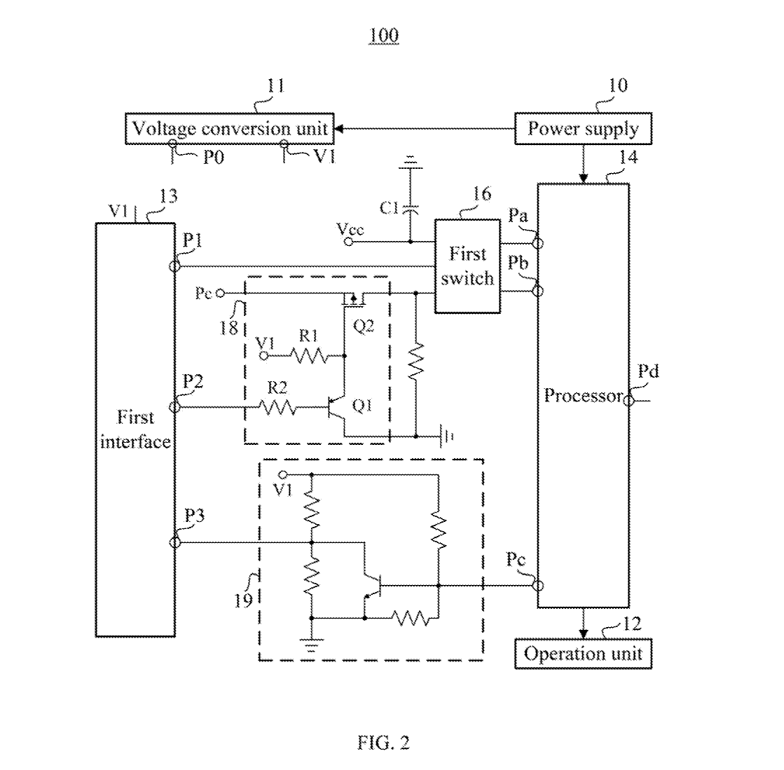

FIG. 2 shows that the control unit 18 includes a first transistor Q1, a second transistor Q2, a first resistor R1, and a second resistor R2. A base of the first transistor Q1 is connected to the second pin P2 through the second resistor R2. A collector of the first transistor Q1 is grounded. An emitter of the first transistor Q1 is connected to the voltage output pin V1. A gate of the second transistor Q2 is connected to the emitter of the first transistor Q1. A source of the second transistor Q2 is connected to the first control pin Pc. A drain of the second transistor Q2 is connected to the first selecting switch 16. In the embodiment, the first transistor Q1 is a pnp type bipolar junction transistor; and the second transistor Q2 is a p-channel enhancement type metal oxide semiconductor field effect transistor (MOSFET).

A working method of the protection circuit 300 is described as follow. When the electronic device 100 connects with the interface apparatus 200 and no operation is occurring on the electronic device 100, the trigger pin P4 outputs the connecting signal to the first interface 13. The second pin P2 transmits the connecting signal to the detecting pin P0, the first enable pin Pd, and the control unit 18. The voltage conversion unit 11 converts the working voltage into the driving voltage and outputs the driving voltage to the first interface 13, the first switch 16, the control unit 18, and the inverter unit 19. The first interface 13 further outputs the driving voltage to power the second interface 22. The first control pin Pc outputs the first control signal to the control unit and the inverter unit 19 in the predetermined time period. A voltage difference between the base and the emitter of the first transistor Q1 is less than 0V, the first transistor Q1 turns on and the voltage of the gate of the second transistor Q2 is equal to 0V. A voltage difference between the gate and the source of the second transistor Q2 is less than 0V, the second transistor Q2 turns on. The first switch 16 establishes the connection between the first pin P1 and the first output pin Pa. At the same time, the inverter unit 19 inverts the first control signal into the second control signal and transmits to the second control pin P6 through the third pin P3 of the first interface 13. The second switch 24 establishes the connection between the second output pin P7 and the transmitted pin P5. When there is no operation generated by the operation unit 12, the processor 15 generates the default selecting signal and transmits the default selecting signal to the second output pin P7. When the operation unit 12 generates a corresponding selecting signal according to the operation of users, the processor 15 transmits the corresponding selecting signal to the second output pin P7. The second input pin P8 is connected to the interface post 201 in response to the default selecting signal.

After the predetermined time period, the first control pin Pc outputs the second control signal. The voltage difference between the base and the emitter of the first transistor Q1 is more than 0V, the first transistor Q1 turns off and the voltage of the gate of the second transistor Q2 is more than 0V. The voltage difference between the gate and the source of the second transistor Q2 is more than 0V, the second transistor Q2 turns off. The first switch 16 establishes the connection between the first pin P1 and the first input pin Pa. At the same time, the inverter unit 19 inverts the second control signal into the first control signal and transmits to the second control pin P6 through the third pin P3 of the first interface 13. The second switch 24 establishes the connection between the second input pin P8 and the transmitted pin P5. The information of the external device 31 is transmitted to the electronic device 100 through the interface port 201, the selection unit 24, the second switch 26, and the second interface 22 in that order.

In use, the electronic device 100 starts to powers the interface apparatus 200 while being connected, and controls the interface apparatus 200 to automatically selects one of the interface ports 201-20n to connect with the electronic device 100 when there is no operation generated by the electronic device 100. The size of the interface apparatus 200 is reduced, and the difficulty in interface apparatus 200 design processor is improved.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An interface apparatus capable of connecting with a plurality of external devices and an electronic device; the electronic device capable of generating control signals and a selecting signal when being connected with the interface apparatus, the interface apparatus comprising:
an interface for connecting and intercommunicating with the electronic device;
a plurality of interface ports for respectively connecting with a plurality of external devices in a one-to-one relationship;
a selection unit connects with the interface ports; and
a switch connected between the interface and the selection unit;
wherein the interface controls the switch to establish a connection between the selection unit and the interface in response to the first control signal for transmitting the selecting signal to the selection unit, the selection unit selects the interface port corresponding to the selecting signal to connect with the switch; the interface further transmits information from the external device corresponding to the selected interface port to the electronic device through the switch and the interface in that order in response to the second control signal.

2. The interface apparatus of claim 1, wherein the selection unit comprises an input pin and an output pin; the electronic device outputs a first control signal in a predetermined time period when the interface apparatus connects with the electronic device and outputs a second control signal after the predetermined time period, the input pin connects with the switch in response to the first control signal for receiving the selecting signal; the output pin connects with the switch in response to the second control signal for transmitting the information.

3. The interface apparatus of claim 1, wherein the electronic device further outputs a driving voltage to the interface apparatus when being connected with the interface apparatus; the selection unit comprises an enable pin; the interface further transmits the driving voltage to the enable pin and the second switch for powering the selection unit and the switch.

4. The interface apparatus of claim 3, wherein the interface apparatus further outputs a connecting signal to the electronic device when the interface apparatus connects with the electronic device; the electronic device outputs the first control signal in response to the connecting signal.

5. The interface apparatus of claim 1, wherein when there is no operation generated in the electronic device in the predetermined time period, the electronic device outputs a default selecting signal to the interface apparatus; the selection unit automatically selects the interface port corresponding to the default selecting signal to connect with the second switch.

6. An electronic device capable of connecting with a plurality of external devices through an interface apparatus with a plurality of interface ports which connects with the external devices in a one-to-one relationship, the electronic device comprising:
a first interface unit for connecting to the interface apparatus;
a processor connected to the first interface unit;
a first switch connected between the first interface and the processor, and capable of establishing different connections between the first interface and the processor; and
a control unit connected between the first switch and the processor;
wherein when the interface apparatus connects with the electronic device, the processor transmits a default selecting signal to the interface apparatus for controlling the interface apparatus to automatically connect with the interface port corresponding to the default selecting signal.

7. The electronic device of claim 6, wherein the processor comprises a first output pin and a first input pin; when the interface apparatus connects with the electronic device, the processor further generates a first control signal, the control unit controls the first switch to establish a connection between the first interface and the first output pin for transmitting the selecting signal to the interface apparatus; the processor further outputs a second control signal after the predetermined time period, the control unit controls the first switch to establish a connection between the first interface and the first input pin for receiving information from the external device.

8. The electronic device of claim 7, further comprising an inverter unit, wherein the inverter unit is connected between the first interface and the processor; the interface apparatus further comprises a second interface, a selection unit, and a second switch; the inverter unit inverts the first control signal to the second control signal in the predetermined time period and inverts the second control signal to the first signal after the predetermined time period; the second interface controls the second switch to establish a connection between the selection unit and the second interface in response to the second control signal inverted by the inverter unit for transmission of the selecting signal to the selection unit; the second interface further transmits information from the external device corresponding to the selected interface port to the electronic device through the second switch and the second interface in that order in response to the first control signal inverted by the inverter unit.

9. The electronic device of claim 8, wherein the control unit comprises a first transistor, a second transistor, a first resistor, and a second resistor; a base of the first transistor is connected to the second pin through the second resistor; a collector of the first transistor is grounded; an emitter of the first transistor is connected to the voltage output pin; a gate of the second transistor is connected to the emitter of the first transistor; a source of the second transistor is connected to the first control pin; a drain of the second transistor is connected to the first selecting switch.

10. The electronic device of claim 6, further comprising a power supply and a voltage conversion unit; wherein the power supply outputs a working voltage to the voltage conversion unit; the interface apparatus further outputs a connecting signal to the electronic device; the voltage conversion unit converts the working voltage into a driving voltage and transmits to the interface apparatus for driving the interface apparatus.

11. The electronic device of claim 1, further comprising an operation unit, wherein the operation unit is connected to the processor; the operation unit generates different selecting signals based on different operations of users to the processor, and the processor stops transmitting the default selecting signal and transmits the corresponding selecting signal generated by the operation unit.

12. An electronic device capable of connecting with a plurality of external devices through an interface apparatus with a plurality of interface ports which connects with the external devices in a one-to-one relationship, the electronic device comprising:
a first interface unit capable of connecting to the interface apparatus;
a power supply providing a working voltage; and
a voltage conversion unit;
wherein when the electronic device connects to the interface apparatus, the voltage conversion unit converts the working voltage into a driving voltage and transmits the driving voltage to the interface apparatus for driving the interface apparatus.

13. The electronic device of claim 12, wherein when the interface apparatus further outputs a connecting signal to the electronic device; the connecting signal is a logic-low signal.

14. The electronic device of claim 12, further comprising a processor, a first switch, and a control unit; wherein the first switch is connected between the first interface; the control unit connected between the first switch and the processor; when the interface apparatus connects with the electronic device, the processor transmits a default selecting signal to the interface apparatus for controlling the interface apparatus to automatically connect with the interface port corresponding to the default selecting signal.

15. The electronic device of claim 14, wherein the processor comprises a first output pin and a first input pin; when the interface apparatus connects with the electronic device, the processor further generates a first control signal, the control unit controls the first switch to establish a connection between the first interface and the first output pin for transmitting the selecting signal to the interface apparatus; the processor further outputs a second control signal after the predetermined time period, the control unit controls the first switch to establish a connection between the first interface and the first input pin for receiving information from the external device.

16. The electronic device of claim 14, further comprising an inverter unit, wherein the inverter unit is connected between the first interface and the processor; the interface apparatus further comprises a second interface, a selection unit, and a second switch; the inverter unit inverts the first control signal to the second control signal in the predetermined time period and inverts the second control signal to the first signal after the predetermined time period; the second interface controls the second switch to establish a connection between the selection unit and the second interface in response to the second control signal inverted by the inverter unit for transmission of the selecting signal to the selection unit; the second interface further transmits information from the external device corresponding to the selected interface port to the electronic device through the second switch and the second interface in that order in response to the first control signal inverted by the inverter unit.

17. The electronic device of claim 16, wherein the control unit comprises a first transistor, a second transistor, a first resistor, and a second resistor; a base of the first transistor is connected to the second pin through the second resistor; a collector of the first transistor is grounded; an emitter of the first transistor is connected to the voltage output pin; a gate of the second transistor is connected to the emitter of the first transistor; a source of the second transistor is connected to the first control pin; a drain of the second transistor is connected to the first selecting switch.

18. The electronic device of claim 17, wherein the first transistor is a pnp type bipolar junction transistor; and the second transistor is a p-channel enhancement type metal oxide semiconductor field effect transistor.

19. The electronic device of claim 14, further comprising an operation unit, wherein the operation unit is connected to the processor; the operation unit generates different selecting signals to the processor based on different operations of users; and the processor stops transmitting the default selecting signal and transmits the corresponding selecting signal generated by the operation unit.
